(19) United States
(12) Patent Application Publication
(10) Pub. No.: US 2013/0317818 A1
(43) Pub. Date: Nov. 28, 2013

(54) Systems and Methods for Captioning by Non-Experts

(71) Applicant: University of Rochester, Rochester, NY (US)

(72) Inventors: Jeffrey P. Bigham, Rochester, NY (US); Walter Laceski, Rochester, NY (US)

(21) Appl. No.: 13/902,709

(22) Filed: May 24, 2013

Related U.S. Application Data
(60) Provisional application No. 61/651,325, filed on May 24, 2012.

(51) Int. Cl. G10L 15/26

(52) U.S. Cl. CPC G10L 15/265
USPC 704/235

(57) ABSTRACT

Methods and systems for captioning speech in real-time are provided. Embodiments utilize captionists, who may be non-expert captionists, to transcribe a speech using a worker interface. Each worker is provided with the speech or portions of the speech, and is asked to transcribe all or portions of what they receive. The transcriptions received from each worker are aligned and combined to create a resulting caption. Automated speech recognition systems may be integrated by serving in the role of one or more workers, or integrated in other ways. Workers may work locally (able to hear the speech) and/or workers may work remotely, the speech being provided to them as an audio stream. Worker performance may be measured and used to provide feedback into the system such that overall performance is improved.

### CROSS-REFERENCE TO RELATED APPLICATIONS

This application claims priority to U.S. Provisional Application No. 61/651,325, filed on May 24, 2012, now pending, the disclosure of which is incorporated herein by reference.

### STATEMENT REGARDING FEDERALLY SPONSORED RESEARCH

This invention was made with government support under contract no. #IIS-1218209 and #IIS-1149709 awarded by the National Science Foundation. The government has certain rights in the invention.

### FIELD OF THE INVENTION

The invention relates to captioning audio, more particularly, captioning audio in real-time (or near real-time) by non-experts.

### BACKGROUND OF THE INVENTION

Real-time speech transcription is necessary to provide access to mainstream classrooms and live events for deaf and hard-of-hearing (“DHH”) people. While visual access to spoken material can be achieved through sign language interpreters, many DHH people do not know sign language. Captioning can also be more accurate in many domains because it does not involve transliterating to another language, but instead transcribing an aural representation to a written one.

Real-time transcription is currently limited by the cost and availability of professional captionists, and the quality of automatic speech recognition (“ASR”). Communications Access Real-Time Translation (“CART”) is the most reliable real-time captioning service, but is also the most expensive. Trained stenographers type in shorthand on a “steno” keyboard that maps multiple key presses to phonemes that are expanded to verbatim text. Stenography requires 2-3 years of training to consistently keep up with natural speaking rates that average around 141 words per minute (“WPM”) and can reach 231 WPM or higher. Such professional captionists (stenographers) provide the best real-time (within a few seconds) captions. Their accuracy is generally over 95%, but generally they must be arranged in advance for blocks of at least an hour, and cost between $120 and $200 per hour, depending on skill. As a result, they cannot be used to caption a lecture or other event at the last minute, or provide access to unpredictable and ephemeral learning opportunities, such as conversations with peers after class.

Another approach is respeaking, where a person in a controlled environment is connected to a live audio feed and repeats what they hear to an ASR that is extensively trained for their voice. Respeaking works well for offline transcription, but simultaneous speaking and listening requires professional training.

On the other hand, non-experts (people not trained to transcribe) are able to understand spoken language with relative ease, but generally lack the ability to record it at sufficient speed and accuracy. An average person can transcribe roughly 38-40 words per minute (“wpm”), but the average English speaker speaks at around 150 wpm. Thus, it is unlikely that a single worker, without special skills, can generate a complete transcription of a speech.

### BRIEF SUMMARY OF THE INVENTION

The present disclosure provides systems and methods for having groups of captionists, which may comprise non-expert captionists (i.e., anyone who can hear and type), collectively caption speech in real-time. The term “caption” is intended to be broadly interpreted to mean any form of converting speech to text, including, but not limited to, transcribe and subtitle. This new approach is further described via an exemplary embodiment called LEGION: SCRIBE (henceforth “SCRIBE”), an end-to-end system allowing collective instantaneous captioning for events, including live events on-demand. Since each individual is unable to type fast enough to keep up with natural speaking rates, SCRIBE automatically combines multiple inputs into a final caption.

Non-expert captionists can be drawn from more diverse labor pools than professional captionists, and so it is expected that captioning by groups of non-experts to be cheaper and more easily available on demand. For instance, workers on Amazon.com's “Mechanical Turk” can be recruited within a few seconds. Recruiting from a broader pool allows workers to be selectively chosen for their expertise not in captioning but in the technical areas covered in a lecture. While professional stenographers type faster and more accurately than most crowd workers, they are not necessarily experts in other fields, which often distorts the meaning of transcripts of technical talks. The present disclosure allows workers, such as student workers, to serve as non-expert captionists for a fraction of the cost of a professional. Therefore, several students can be hired for less than the cost of one professional captionist.

SCRIBE can benefit people who are not deaf or hard-of-hearing as well. For example, students can easily and affordably obtain searchable text transcripts of a lecture even before the class ends, enabling them to review earlier content they may have missed.

Furthermore, people are subject to a situational disability from time to time. Even a person with excellent hearing can have trouble following a lecture when sitting too far from the speaker, when acoustics are poor, or when it is too noisy.

### DESCRIPTION OF THE DRAWINGS

For a fuller understanding of the nature and objects of the invention, reference should be made to the following detailed description taken in conjunction with the accompanying drawings, in which:

FIG. 1 is a diagram depicting the exemplary SCRIBE system that allows users to caption audio on their mobile device;

FIG. 2 shows partial captions by an ASR and five Mechanical Turk workers for a segment of speech, showing that merging the input of multiple non-expert workers results in accurate, real-time captions (wherein the left edge of each box represents the time when the typed word was received, and boxes are color-coded to show word position—e.g., red denotes incorrect text);

FIG. 3 shows example output of the exemplary MSA algorithm wherein each line is a partial caption input by a worker, and the final merged caption (F), dashes represent “gaps” inserted to attain an optimal alignment given the language model;

FIG. 4 depicts an exemplary worker interface which encourages captionists to type audio quickly by locking in words soon after they are typed and encourages coverage of specific segments by the use of visual and audio cues (and the volume is reduced during off periods);

FIG. 5 depicts an exemplary web-based user interface for users to see and correct the live caption stream returned by SCRIBE;

FIG. 6 depicts audio segmented using an exemplary kernel SVM method wherein each segment contains audio from one speaker, and is sent to different workers;

FIG. 7 is a visual representation of where SCRIBE encourages workers to type different portions of the input speech by raising and lowering the volume of the audio; FIG. 8 is a graph building for three workers captioning the spoken sentence “Open the Java code up now and . . . ” wherein the top section shows the current state of the graph after each stage and the bottom shows the corresponding input (note that Worker 2 spelling ‘file’ incorrectly does not adversely affect the graph since a majority of the workers still spell it correctly);

FIG. 9 is a graph having plots of precision and coverage for MSA with artificial saliency adjustments (labeled ‘Adj.’) and without such adjustments, and including their theoretical upper bounds for the exemplary embodiment;

FIG. 10 is a graph showing optimal coverage for the exemplary embodiment reaching nearly 80% when combining the input of four workers, and nearly 95% with all 10 workers;

FIG. 11 depicts word error rate (WER) results for the tested captioning systems;

FIG. 12 depicts precision results for the captioning systems of FIG. 11;

FIG. 13 is a graph including precision-coverage curves for electrical engineering (EE) and chemistry (Chem) lectures using different combiner parameters with ten workers, showing that, in general, increasing coverage reduces accuracy;

FIG. 14 shows captions generated by different captioning systems (CART, SCRIBE, and ASR) illustrating common errors and tradeoffs (words are shaded based on 2-second time spans—ASR and (to a lesser extent) CART captions arrive in bursts, disrupting the ‘flow’);

FIG. 15 is a graph showing the average coverage for groups of 1-10 workers on four different classroom audio clips (ASR averaged 17.99%);

FIG. 16 is a graph showing the average accuracy for groups of 1-10 workers on four different classroom audio clips (ASR averaged 43.94%);

FIG. 17 shows an example of adaptive segment duration adjustment over time wherein the unobscured text shows what a worker was able to cover in the segment they were asked to caption (the greyed out portion is what the worker was not asked to caption);

FIG. 18 is an illustration depicting altering the speed of audio streams;

FIG. 19 is a diagram depicting a system according to another embodiment of the present disclosure; and

FIG. 20 is a flowchart depicting a method according to another embodiment of the present disclosure.

### DETAILED DESCRIPTION OF THE INVENTION

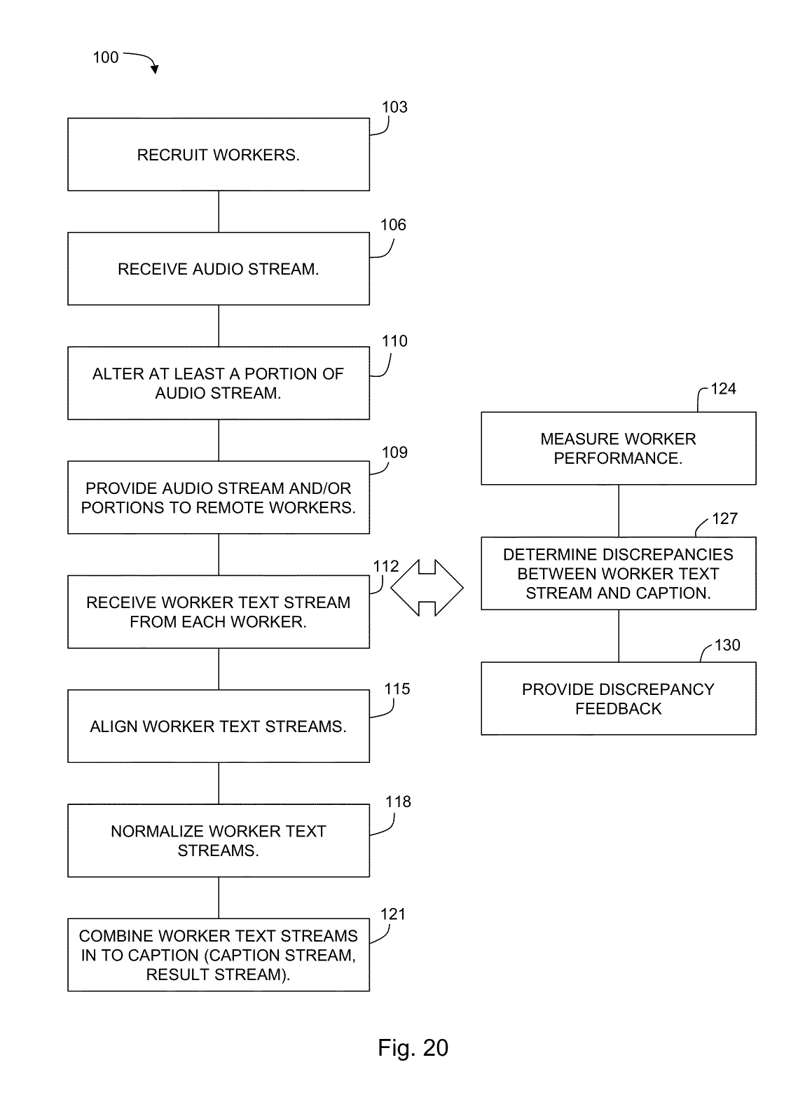

The present disclosure may be embodied as a method 100 for captioning aural speech using a plurality of workers (sometimes referred to as a “crowd”) (see, e.g., FIG. 20). The method 100 may be used to generate a caption of the speech in real-time such that the generated caption lags the original speech (i.e., latency) by no more than 5-10 seconds (i.e., near real-time or, effectively, “real-time”). The method 100 may include the step of recruiting 103 workers to transcribe the speech. Workers may be local workers, such as students or volunteers present at the venue of the aural speech. Workers may be remote workers, such as people recruited from the web using services such as Mechanical Turk from Amazon.com. Workers present at the venue, who would otherwise be considered local workers, may also be considered remote workers where they are able to use devices such as, for example, headphones. In other embodiments of the method 100, workers can be both local and remote.

Systems and methods of the present disclosure only require workers to be able to hear and type. The crowd may be a dynamic pool of workers available on-demand. As a result, no specific worker can be relied upon to be available at a given time or to continue working on a job for any amount of time. Workers sometimes cannot be relied upon to provide high-quality work of the type one might expect from a traditional employee. This stems from the lack of direct control, misunderstanding of the task, or delays that are beyond their control, such as network latency. Using multiple workers decreases the likelihood that no worker will be able to provide a correct caption quickly.

Workers may be local or remote. Local workers are able to hear the audio with no communication delay, and at the original audio quality. For example, local workers may be students attending a lecture. These workers may be more familiar with the topic being discussed, and may already be used to the style of the speaker. Remote workers are those that are not able to hear the audio except through a communication network. Remote workers are easier to recruit on-demand, and are generally cheaper. However, remote workers may not be trained on the specific speaker, and may lack the background knowledge of a local worker. Workers may be recruited specifically for their subject matter expertise. These two types of workers can be mixed in order to extract the best properties of each. For instance, using local workers to take advantage of the low latency when possible, while using remote workers to maintain enough captionists to ensure consistent coverage.

The method 100 may comprise the steps of receiving 106 an electronic audio stream of the speech and providing 109 the audio stream to the remote workers. The aural speech may be recorded into an electronic audio stream at the source in any way known in the art using any appropriate device such as, for example, a mobile phone or a laptop computer. The electronic audio stream can be received 106 by a computer, for example a server computer. The electronic audio stream is provided 109 to at least the remote users, and in some embodiments of the invention, is provided to one or more local workers. The workers may be provided 109 with the entire audio stream or a portion of the electronic audio stream. When provided 109 with a portion of the audio stream, workers can be provided with the different portions of the audio stream such that, in aggregate, the entire audio stream is provided 109 to the workers. More than one worker may be provided 109 with the same portions so that each portion of the audio stream is provided 109 to more than one worker. As such, the portions of the audio stream may be provided 109 to workers such that each portion is provided to at least one worker, but in some embodiments of the method 100, more than one worker.

The portions of the audio stream provided 109 to each worker may be fixed such that a worker receives a fixed duration portion to process. In other embodiments of the method 100, the duration of the portion provided 109 to a particular worker is variable. For example, the portion provided 109 to a particular worker may be determined dynamically based on the performance of that worker. Further examples and details are provided below.

The portions of the audio stream provided 109 to the remote workers may be altered 110 to change the saliency of the audio. For example, the portion(s) of the audio stream may be altered 110 by increasing the volume of the portion(s) (i.e., altering the audio such that the portion is louder than the other remainder of the audio), slowing the speed of the portion(s), or other audio transformations, and combinations. These alterations are exemplary and any alteration of the audio, such as, for example, to make the audio easier for workers to caption, or to direct workers to the portion of the audio they are instructed to caption to increase the saliency of the audio, should be considered within the scope of the present invention. In this way, workers will be more likely to accurately transcribe the altered 110 portion(s) of the audio stream. Such alterations may also serve as a prompt to the worker such that the worker knows to focus his or her transcription efforts on the altered portion(s).

Similarly, in embodiments where the entire audio stream is provided to each worker, portions of the audio stream may be altered 110 to change the saliency. In this manner, a worker may be directed to transcribe only certain portions of the speech, and those portions may be altered 110 to serve as a cue to the worker as to the portions for transcription. By providing the entire audio stream, the worker may better comprehend the context of the speech portions to be transcribed. For example, a worker may be provided with the entire audio stream, and portions of the audio stream are altered 110 such that the some portions are louder than other portions. The inverse of this may be considered to be the same operation, wherein some portions of the audio stream are altered 110 to make those portions quieter than other portions of the audio stream. Likewise, the inverse of any alteration may be considered to be the same as the alteration (e.g., slower portions/faster portions, etc.)

Each worker will transcribe the appropriate portion of the audio stream for that worker (e.g., that portion provided 109 to the worker, that portion identified by alteration 110, etc.) As mentioned above, each worker may transcribe the audio stream (i.e., the aural speech contained within the aural speech) with errors. Each worker transcribes at least a portion of the audio stream into a worker text stream using an appropriate device and the worker text stream is transmitted to a computer, such as a server. The worker text streams are received 112 from each worker. It should be noted that the worker text streams may be received 112 at any time. For example, each worker may create (at the same time or at different times) a corresponding worker text stream and the worker text streams can then be stored. The stored worker text streams can then be received 112. In this way, text streams can be combined (further described below) regardless of how or when the strings were created.

The method 100 may include the step of locking text such that the worker text streams are unalterable by the worker after they are locked. For example, each word of the worker text stream may lock immediately upon entry or after a period of time (e.g., 500 milliseconds, 800 milliseconds, 1, 2, 5, 10 seconds, etc.) after the word has been entered. In this way, workers are encouraged to work in real-time—without returning to correct previous text entry. New words may be identified when the captionist types a space after the word, and are sent to the server. A short delay before locking may be added to allow workers to correct their input while minimizing the added latency. In a particular embodiment, when the captionist presses enter (or following a 2-second timeout during which they have not typed anything), the line is locked and animates upward.

Due to variables such as network latency, worker speed, worker errors, etc., the worker text streams will likely not arrive in synchronicity. In other words, a particular passage of the aural speech transcribed by two or more workers may be received at different times. Therefore, the worker text streams are aligned 115 with one another. Workers have different typing speeds, captioning styles, and connection latencies, making time alone a poor signal for word ordering. Aligning 115 based on word matching can be more consistent between workers, but spelling mistakes, typographical errors, and confusion on the part of workers make finding a consensus difficult. A robust alignment 115 technique should be able to handle these inconsistencies, while not overestimating the similarity of two inputs.

Using worker input exclusively may fail to take advantage of existing knowledge of languages and common errors. Also, workers may submit semantically equivalent captions that differ from those of other workers (e.g., differences in writing style, different use of contractions, misspellings, etc.) In some embodiments, the worker text streams are normalized 118 using, for example, additional information about the most likely intended input from a worker through the use of language and typing models. Rules may be used to normalize 118 the input from workers without altering the meaning. For example, as a language model, bigram and trigram data from Google's publicly available N-gram corpus may be used. This provides prior probabilities on sets of words, which can be used to resolve ordering conflicts in workers' input. In another exemplary language model, prior captions either from the current session or another session may also be used to form language models specific to the person, subject, etc. In general, language models specific to the topic may be selected either beforehand or selected based on captions provided by embodiments of the present invention. An exemplary typing model is to determine equivalent words using the Damerau-Levenshtein distance between the words, which may be weighted using the Manhattan distance between the letters on a QWERTY keyboard. In other examples, the text of each worker text stream may be analyzed and contractions replaced with equivalent words, spelling errors detected and replaced, etc.

In order to successfully generate complete and accurate captions, the noisy partial inputs (worker text streams) need to be merged into a single result stream (caption). The aligned 115 worker text streams are combined 121 into a caption of the aural speech based on agreement of the aligned worker text streams. The combining 121 can be based on worker agreement where the aligned 115 streams are compared to one another and the text with the highest level of agreement between workers is selected as the text for the caption. The performance of one or more of the workers may be measured 124 by, for example, determining the level of agreement between a particular worker and the other workers (or the final caption).

In some embodiments, one of the workers is an automated speech recognition system (“ASR” or “ASR System”). The ASR may transcribe the received speech and provide a worker text stream that is received 112 by the server. The worker text stream received 112 from the ASR will be similar to that received 112 from other workers. It is known in the art that ASRs can rely on different speech recognition algorithms. Additionally, it is known that some ASRs can be trained to better recognize certain speech in certain settings, for example, an ASR may be trained to recognize the speech of a speaker with an accent. As such, in some embodiments, more than one ASR may be used. In such embodiments, it is advantageous to use different ASRs, such as ASRs with different algorithms, training, etc.

The method 100 may comprise the step of determining 127 discrepancies between a worker text stream and the caption (the final, combined transcription). The determined 127 discrepancies may then be used to provide 130 discrepancy feedback. For example, discrepancies determined 127 in an ASR worker text stream may be used to further train the ASR. In this way, the ASR may be continuously trained. In other examples, determined 127 discrepancies may be used to refine language model(s), spelling model(s), speaker model(s), acoustic model(s), etc.

In some embodiments, an ASR may be used for providing measures such as providing a word count and/or word order. As such the ASR can be used to improve the quality of the caption without the ASR having provided a transcript.

In embodiments comprising the step of recruiting 103 workers, this step may be performed once (such as, for example, at the beginning of the process), or the step may be performed more than once. For example, additional workers may be recruited 103 if it is determined during the captioning process, that the quality of the caption should be improved (e.g., poor worker performance, insufficient quantity of workers, latency too high, etc.) Other reasons for recruiting 103 workers will be apparent in light of the present disclosure and should be considered within the present scope.

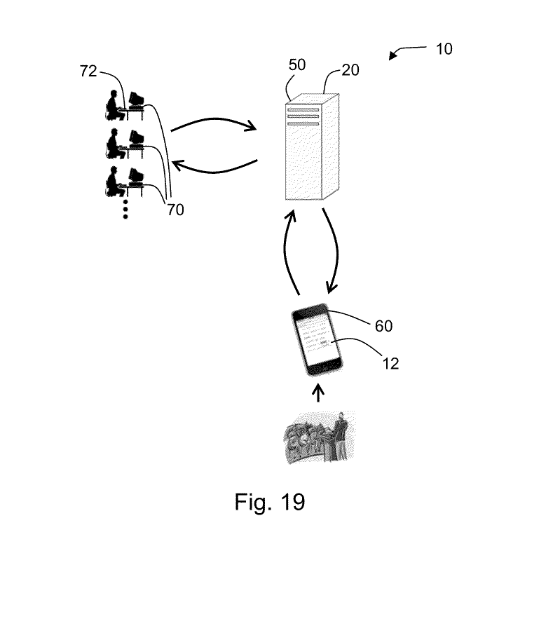

The present disclosure may be embodied in a system 10 for captioning aural speech using a plurality of workers (see, e.g., FIG. 19). In some embodiments, the system 10 comprises a user interface 12 for requesting a transcript of the aural speech. For example, the system 10 may comprise a server computer 50 having a web server, and the user interface 12 may be provided to a user requesting a transcription by the web server. The user interface 12 may be configured to cooperate with an audio input device 13 to convert the aural speech into an audio stream. In the exemplary embodiment where the user interface 12 is presented to the user by a web server, the user may access the web server using a mobile device 60 such as, for example, a laptop computer, a tablet, or a smartphone. In this embodiment, the user interface 12 may cooperate with a microphone 62 of the mobile device 60 to convert the speech into an electronic audio stream. In some embodiments, the audio stream may be stored for subsequent retrieval.

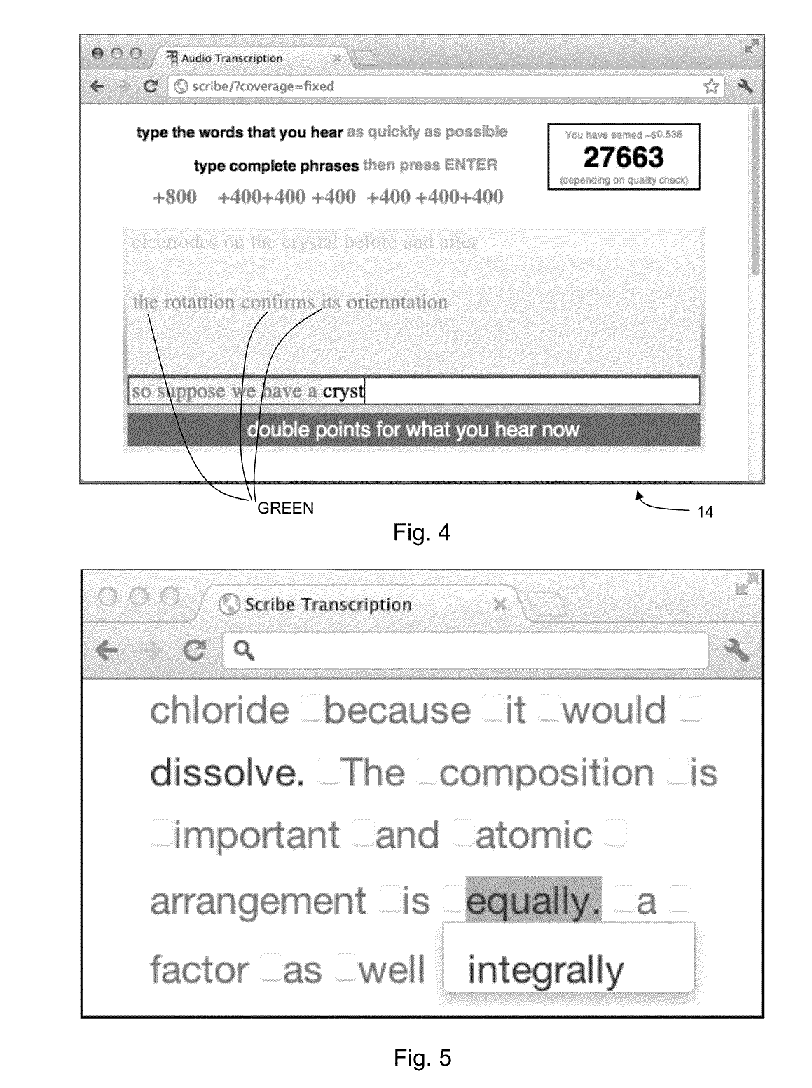

The system 10 comprises a worker interface 14 (see, e.g., FIG. 4) accessible by workers. In an exemplary embodiment, the worker interface 14 is provided by a server computer 50 using a web server. The worker interface 14 may be accessed by a plurality of workers (and may be considered a plurality of worker interfaces 14). Each worker may use a device 70, such as, for example, a desktop or laptop computer, a tablet, a smartphone, or any other suitable device. It should be noted that the user and worker devices are not limited to mobile devices, and other suitable devices are known and within the scope of the present disclosure. Additionally, all workers and/or users need not use the same type of device (e.g., a worker might use a desktop computer, while another uses a tablet, while still another uses a laptop). The worker interfaces 14 may provide worker audio streams to the workers. Each worker interface 14 is configured to receive text from the worker by way of an input device 72 of the device 70, such as, for example, a keyboard. In this manner, a worker may use the worker interface 14 to listen to an audio stream and type what they hear using a keyboard. The text is received by the system 10 from the worker interface 14 as a worker text stream (i.e., “transmitted” from the worker interface 14). In another embodiment the worker interface 14 may be one or more pre-existing interface, such as, for example, Twitter.

The worker interface 14 may be configured to lock text entered by a worker using the worker interface 14 such that the resulting worker text stream is unalterable by the worker after it is locked. For example, the worker interface 14 may be configured to lock each word of the worker text stream immediately upon entry or after a period of time (e.g., 500 milliseconds, 800 milliseconds, 1, 2, 5, 10 seconds, etc.) after the word has been entered. In this way, workers are encouraged to work in real-time—without returning to correct previous text entry. The worker interface 14 may be configured to provide feedback to the worker based on language models, spelling models, agreement with other workers, or other bases or combinations thereof. For example, the worker interface 14 may be configured to change the color of correct words and/or incorrect words, provide audible cues, provide rewards (e.g., point scores, payment increments, etc.) to the worker for correct words, etc.

The system 10 comprises a transcription processor 20. In an exemplary embodiment, the transcription processor 20 may be the server computer 50 or a portion of a server computer 50. The transcription processor 20 may be a separate processor. The transaction processor 20 is configured to communicate with the worker interfaces 14. In some embodiments, the transcription processor 20 is configured to communicate with the user interface 12. The transcription processor 20 is programmed to perform any of the methods of the present disclosure. For example, the transcription processor 20 may be programmed to retrieve an audio stream. For example, the transcription processor 20 may be programmed to retrieve the audio stream from the user interface 12, retrieve a stored audio stream, or retrieve the audio stream in other ways which will be apparent in light of the present disclosure. The transcription processor 20 may be further programmed to send at least a portion of the audio stream to each worker interface 14 of the plurality of worker interfaces 14 as the worker audio stream; receive worker text streams from the plurality of worker interfaces 14; align the worker text streams with one another; and combine the aligned worker text streams into a caption stream.

In some embodiments of a system 10, the transcription processor 20 is further programmed to alter the audio saliency of at least one worker audio stream. In this manner, a worker can be prompted to transcribe one or more particular portions of the speech. For example, the transcription processor 20 may alter an audio stream provided to at least one worker such that portions of the audio stream are louder than the remainder of the worker audio stream. As such, the worker is directed to transcribe those portions which are louder than others. Similarly, portions may be slowed-down. Other embodiments are disclosed in this paper and still others will be apparent in light of this paper.

SCRIBE

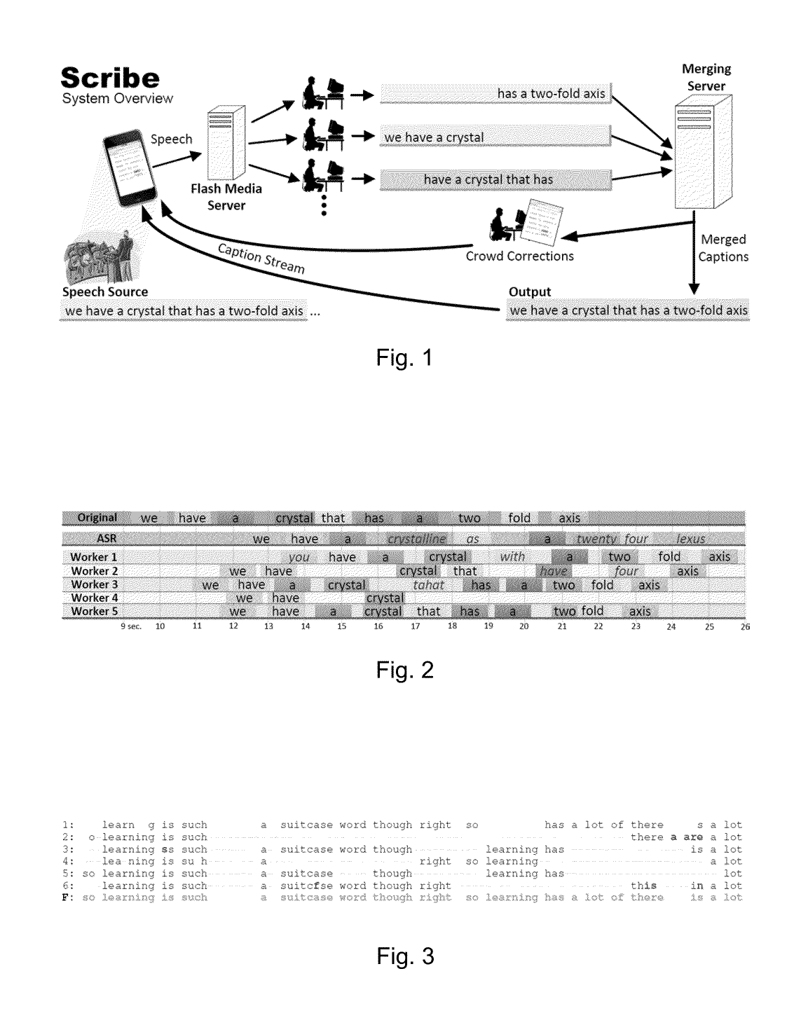

Further details of the present disclosure are provided below with reference to “SCRIBE,” an exemplary (i.e., non-limiting) embodiment of the presently disclosed invention which gives users on-demand access to real-time captioning from groups of non-experts via a laptop or mobile device (FIG. 1). When a user starts SCRIBE, the application immediately begins recruiting workers for the task from Mechanical Turk, or a pool of volunteer workers, using quikTurkit. When users want to begin captioning audio, they press the start button (within a user interface), which forwards audio to Flash Media Server (“FMS”) and signals the SCRIBE server to begin captioning.

Workers are presented with a text input interface (worker interface) designed to encourage real-time answers and increase global coverage (FIG. 4). A display shows workers their rewards for contributing in the form of both money and points. In experiments using SCRIBE, workers were paid $0.005 for every word the system thought was correct. As workers type, their input is forwarded to an input combiner on the SCRIBE server. The input combiner is modular to accommodate different implementations without needing to modify SCRIBE. The combiner and interface are further discussed below.

The user interface for SCRIBE presents streaming text within a collaborative editing framework (see FIG. 5). SCRIBE's interface masks the staggered and delayed format of real-time captions with a more natural flow that mimics writing. In doing this, the interface presents the merged inputs from the crowd workers via a dynamically updating web page, and allows users to focus on reading, instead of tracking changes. SCRIBE also supports real-time editing by users or other crowds. The web interface visually presents relevant information, such as the confidence of each spelling and possible word and arrangement alternatives. These cues both reduce the attention that must be paid to the editing process, and encourage users to focus their efforts on specific problems in the caption. For example, conflicted words or spellings are highlighted and, when selected, alternatives are displayed and can be agreed with or new answers can be added. These updates are then forwarded back to the combiner.

When users are done, pressing the stop button will end the audio stream, but let workers complete their current transcription task. Workers are asked to continue working on other audio for a time to keep them active in order to reduce the response time if users need to resume captioning. In general, the audio stream sent to a worker may change automatically and may not be live content but offline content, i.e., workers could be directed to caption speech asynchronous from its source. Live and offline tasks may be interleaved automatically or at the discretion of the worker.

Collaborative Editing

Multiple users may want to use SCRIBE to generate captions for the same event. SCRIBE's interface supports this by allowing users to share the link to the web interface for a given session to view the generated captions. This allows more captionists from the worker pool to be used for a single task, improving performance. Additionally, the joint session acts as a collaborative editing platform. Each participant in this shared space can submit corrections to the captions, adding their individual knowledge to the system.

Adjustable Quality

Several quality measures were defined and used to characterize the performance of real-time captioning, including coverage, precision, and word error rate (“WER”). Coverage represents how many of the words in the true speech signal appear in the merged caption. While similar to ‘recall’ in information retrieval, in calculating coverage a word in the caption is required to appear no later than 10 seconds after the word in the ground truth, and not before it, to count. Similarly, precision is the fraction of words in the caption that appear in the ground truth within 10 seconds. WER is further described below under the heading Metrics for Evaluating Captioning Systems.

SCRIBE allows for placing emphasis on either coverage or precision. However, these two properties are at odds: using more of the worker input will increase coverage, but maintain more of the individual worker error, while requiring more agreement on individual words will increase precision, but reduce the coverage since not all workers will agree on all words. SCRIBE allows users to either let the system choose a default balance, or select their own balance of precision versus coverage by using a slider bar in the user interface. Workers can select from a continuous range of values between ‘Most Accurate’ and ‘Most Complete’ which are mapped to settings within the combiner.

SCRIBE Worker Interface

FIG. 4 depicts the interface that non-expert captionists use to provide their captions (worker interface). The web-based interface streams audio to the captionists who are instructed to type as much of it as they can. Furthermore, workers are told to separate contiguous sequences of words by pressing enter. Knowing which word sequences are likely to be contiguous can help later when recombining the partial captions from multiple captionists.

To encourage real-time entry of captions, the interface “locks in” words a short time after they are typed (e.g., 800 milliseconds). New words are identified when the captionist types a space after the word, and are sent to the server. The delay is added to allow workers to correct their input while adding as little additional latency as possible to it. When the captionist presses enter (or following a 2-second timeout during which they have not typed anything), the line is confirmed and animates upward. During the 10 second trip to the top of the display, words that SCRIBE determines were entered correctly (by either a spelling match or overlap with another worker) are colored green. When the line reaches the top, a point score is calculated for each word based on its length and whether it has been determined to be correct.

To recover the true speech signal, non-expert captions must cover all of the words in that signal. A primary reason why the partial transcriptions may not fully cover the true signal relates to saliency, which is defined in a linguistic context as “that quality which determines how semantic material is distributed within a sentence or discourse, in terms of the relative emphasis which is placed on its various parts.” Numerous factors may influence what is salient. In an embodiment of SCRIBE, saliency is artificially applied by, for example, systematically varying the volume of the audio signal that captionists hear. The web-based interface is able to vary the volume over a given a period with an assigned offset. It also displays visual reminders of the period to further reinforce this notion. FIG. 7 shows how the volume can be systematically varied to maximize coverage over the whole signal.

In an embodiment, the audio signal is divided into segments that are given to individual workers for transcription. Certain disadvantages may be apparent with such a division. First, workers may take longer to provide their transcription due to the time required to get into the flow of the audio. A continuous stream avoids this problem. Second, the interface may encourage workers to favor quality over speed, whereas a stream that does not stop is a reminder of the real-time nature of the transcription. An embodiment of the SCRIBE continuous interface was designed using an iterative process involving tests with 57 remote and local users with a range of backgrounds and typing abilities. These tests demonstrated that workers generally tended to provide chains of words rather than disjoint words, and that workers needed to be informed of the motivations behind aspects of the interface to use them properly.

Altering the Audio Stream

The web-based SCRIBE interface is able to systematically vary the volume of the audio that captionists hear in order to artificially introduce saliency. To facilitate this, each captionist is assigned an “in-period” and an “out-period.” The in-period is the length of time that a captionist hears audio at a louder volume, and the out-period is the length of time after the in-period that the captionist hears audio at a quieter volume. For example, if the in-period is 4 seconds and the out-period is 6 seconds, the captionist would hear 4 seconds of louder audio, followed by 6 seconds of quieter audio, after which the cycle would immediately repeat until the task is complete. Workers are instructed to transcribe only the audio they hear during the in-periods, and are given extra compensation for correct words occurring during in-periods.

Different methods of assigning in-and out-periods to workers can be employed. For example, a fixed set of periods may be used. In this configuration, the system simply assigns a constant in-period and out-period to each worker. However, in most cases, a constant set of periods is not ideal for a worker, due largely to the wide variation of speaking rates, even within the same piece of audio. To remedy this, another example of assignment is an adaptive method for determining in- and out-periods. In this configuration, the system starts each worker with a pre-determined fixed period, and then uses a weight-learning algorithm to constantly adapt and modify the worker's periods based on their performance. Once a worker completes a segment of audio, the system calculates a weight for the worker, and the in- and out-periods are updated accordingly.

Weight Learning

To determine the periods, an exemplary dynamic method calculates a weight for each worker after each segment. The weight of a worker could be seen as a type of “net words-per-minute” calculation, where a higher weight indicates a faster and more accurate typist. The weight of a worker is calculated according to the following formula:

wᵢ=αwᵢ₋₁+(1−α)p

Where wᵢ is the current weight, wᵢ₋₁ is the previous weight, and p is the performance of the worker in the most recent segment of audio. α is a discount factor which is selected such that 0<α<1. Its effect is that a worker's weight is determined more by recent typing performance. The performance of a worker during the previous segment, p, is computed according to the following formula:

$$p = \frac{n - ( n - c ) d}{t}$$

Where n is the number of total words the worker typed, t is the number of minutes that the worker typed (usually a fraction), c is the number of correct words the worker typed, and d is the error index. The error index is the penalty given to incorrect words, such that if the error index is 1, the equation deducts 1 correct word from the performance calculation. In tests, words were matched to a baseline file containing a full transcription of the audio to determine the number of correct words. While a baseline will not be available in actual use, the goal of testing was to show that adaptive durations may be beneficial. One technique for determining accuracy in actual use is using worker agreement. The use of SCRIBE has shown that 10 workers can accurately cover an average of 93.2% of an audio stream with an average per-word latency of 2.9 seconds. The resulting captions can be used to determine the rate of speech, as well as each worker's performance, by comparing each individual worker's captions to the crowd's result.

Once the weight is determined, it is used to calculate the final period times. In an example, the sum of the in-period and the out-period may be set to a constant value, and the worker's weight is used to determine an optimal ratio between the two. The SCRIBE system supports a variable sum of periods, but a constant value was chosen to make calculations more straightforward. The in-period may be determined according to the following formula:

$$r = T \frac{{w}_{i}}{s}$$

Where r is the in-period, T is the constant total segment time (in-period plus out-period), wᵢ is the current weight, and s is the approximate speaking rate of the audio segment in words per minute.

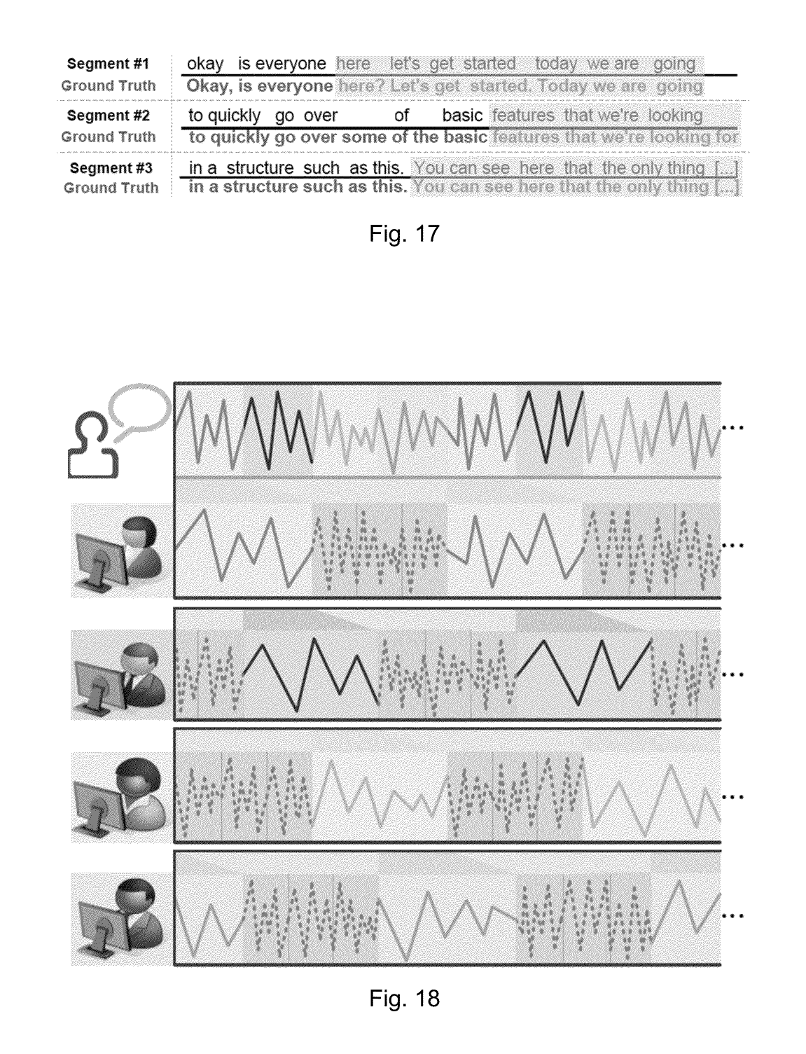

In an illustrative example, FIG. 17 shows three segments of speech a worker was asked to caption (the portion not asked to be captioned by the user is shown in gray). Because the worker captioned all of the words in segment 1, the system automatically increases the load for the next period. When content is missed in segment 2, the load is reduced. Eventually, in segment 3, the worker is covering as much as they can do well, increasing the amount of coverage seen from a single worker, without introducing additional inaccuracies.

Results from testing show that tailoring the captioning task to workers can significantly improve their performance on a task. Workers are able to caption closer to their full capability, instead of higher skilled workers being restricted. Furthermore, allowing the task to change over time means that if workers tire, get distracted, or the speaker changes pace, the system can compensate.

Other options are known and considered within the scope of the present disclosure including combinations of more than one assignment method. For instance, allowing workers to pick their initial segment durations may be provide a more appropriate starting point than using pre-determined durations such that there is a reduction in the time required to find a dynamically-tailored period. In other examples, a time window which is some amount below a worker's maximum ability (for example, 5%, 10%, 20%, etc.) may be used in order to reduce the amount of strain associated with performing a task at the limit of their ability.

To use such dynamic periods in a live system, the system should be capable of correctly scheduling when workers' segments occur. With fixed windows, scheduling is trivial and can be done a priori, however, when segment lengths are unknown and not required to complement each other, the problem becomes more difficult. While dynamic segment lengths allow each worker individually to perform better than static segment lengths would allow, a scheduling mechanism that both covers the entire audio signal should be employed. Such a scheduler may take into account that at any given point in time each worker will have a maximally bounded input period length, as well as minimally bounded rest period length, both of which may change at a moment's notice, which makes it somewhat difficult to continually arrange and rearrange the set of workers so as to cover 100 percent of the signal without prior knowledge of the incoming audio stream.

Transcribing a Dialogue

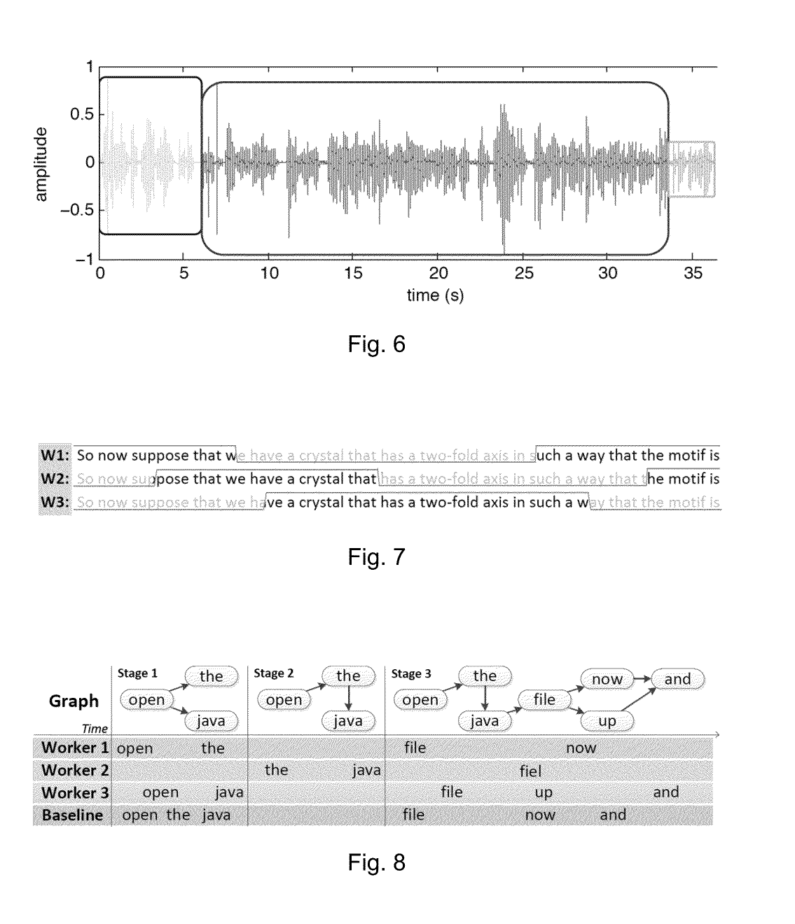

Interleaving different speakers adds an additional layer of complexity to the transcription task. Many ASRs attempt to adapt to a particular speaker's voice; however, if speakers change, this adjustment often reduces the quality of the transcription further. In order to address this problem and enable accurate transcriptions of conversations, even those between individuals with very different speaking styles, the system is capable of either dynamically adjust to the variances, or isolate the separate components of the audio. The exemplary embodiment of SCRIBE addresses dialogues using automated speaker segmentation techniques (FIG. 6). A convolution-based kernel method may be used for identification of distinct segments in a waveform with a one-class support vector machine (“SVM”) classifier to each segment to assign it a speaker ID. Such segmentation techniques have been shown to be accurate even in the presence of severe noise, such as when talking on a cell phone while driving. The segmentation allows for the dialogue to be decomposed in real-time, such that each portion may be captioned individually.

Multiple Sequence Alignment

Another component of SCRIBE is the merging server (transcription server or transcription processor), which uses a selectable algorithm to combine partial captions into a single output stream. A naive approach would be to simply arrange all words in the order in which they arrive, but this approach does not handle reordering, omissions, and inaccuracy within the input captions. A more appropriate algorithm combines timing information, observed overlap between the partial captions, and models of natural language to inform the construction of the final output. The problem of regenerating the original content of continuous speech from a set of n workers can be seen as an instance of the general problem of Multiple Sequence Alignment (“MSA”). While this problem can be solved with a dynamic programming algorithm, the time and space complexity is exponential in the number and length of sequences being combined (n workers submitting k words in the present case). This complexity means that existing MSA algorithms alone are unlikely to be able to solve this problem in real-time. Existing MSA also cannot align ambiguously ordered words, thus requiring a level of coverage that eliminates (or reduces) uncertainty.

MSA packages were further adapted to include a spelling error model based on the physical layout of a keyboard. For example, when a person intends to type an ‘a,’ he is more likely to mistype a ‘q’ than an ‘m.’ The model may be further augmented with, for example, context-based features learned from spelling corrections drawn from the revisions of Wikipedia articles.

Learning a substitution matrix for each pair of characters along with character insertion and deletion penalties allows the use of a robust optimization technique that finds a near-optimal joint alignment. Even though finding the best alignment is computationally expensive, the exemplary SCRIBE system operates in real-time by leveraging dynamic programming and approximations. Once the partial captions are aligned, they are merged (combined) into a single transcript, as shown in FIG. 3. A majority vote technique was used for each column of aligned characters, and the gaps were removed in a post-processing step. The entire computation takes only a few seconds for input several minutes in length. The MSA model may be applied to longer audio signals, while maintaining the real-time aspect of the system, by the use of a sliding window to bound the runtime.

In another exemplary embodiment of dynamic alignment capable of achieving the response-time and scalability advantageous for real-time captioning of longer sessions, a version of MSA that aligns input using a graphical model can be used. Worker captions are modeled as a linked list with nodes containing equivalent words aligned based on sequence order submission time. As words are added, consistent paths arise. The longest self-consistent path between any two nodes is maintained to avoid unnecessary branching. FIG. 8 shows an example of such a graph building process.

Using a greedy search of the graph, in which the highest weight edge (a measure of the likelihood of two words appearing in a row) is always followed, a transcript may be generated in real-time. The greedy search traverses the graph between inferred instances of words by favoring paths between word instances with the highest levels of confidence derived from worker input and n-gram data. Embodiments of the present disclosure may use n-gram corpora tailored to the domain of the audio clips being transcribed, either by generating them in real time along with the graph model, or by pre-processing language from similar contexts. For example, specific n-gram data can provide more accurate transcription of technical language by improving the accuracy of the model used to infer word ordering in ambiguous cases.

The greedy graph traversal favors paths through the graph with high worker confidence, and omits entirely words contained within branches of the graph that contain unique instances of words. A post-processing step augments the initial sequence by adding into it any word instances with high worker confidence that were not already included. Because the rest of the branch is not included, these words can be disconnected from words adjacent in the original audio The positioning of these words are added back into the transcript by considering the most likely sequence given their timestamps and the bigrams and trigrams that result from their insertion into the transcription. After this post-processing is complete the current transcript is forwarded back to the user.

Each time a worker submits new input, a node is added to the worker's input chain. A hash map containing all existing unique words spoken so far in the stream is then used to find a set of equivalent terms. The newest element can always be used since the guarantee of increasing timestamps means that the most recent occurrence will always be the best fit. The match is then checked to see if a connection between the two nodes would form a back-edge. Using this approach allows for the reduction of the runtime from worst-case O(n^{k}) to O(n). The runtime of this algorithm can be further reduced by limiting the amount of data stored in the graph at any one time because it can be assumed that the latency with which any worker submits a response is limited. In practice, a 10-second time window is effective, though SCRIBE was able to incrementally build the graph and generate output within a few milliseconds for time windows beyond 5 minutes.

In another embodiment, a dependency-graph model is used to track word ordering and remove ambiguity. The graph is composed of elements that each store a set of equivalent words. These elements track the lowest timestamp of a word and the most common spelling. It may be assumed that each worker will provide captions in the correct order. When a input is received, a lookup table is used to find the best fitting element (based on time stamp) that occurs as a descendant of the previous word input by the same worker. If no matching element is found, a new element is created, the word is added, and a link between the new element and the element containing the last word entered by the user is added. Finally, the graph is updated to ensure only the longest path between each pair of elements is maintained. The graph can then use statistical data to merge the branches in the graph back together to form the caption. To prevent unbounded growth, elements with timestamps older than, for example, 15 seconds may be pruned from the actively updating graph and write them to a permanent transcript. This graph thus allows new input to be added incrementally, with updates taking less than 2 ms on average.

Normalization

Worker input streams were analyzed and it was found that many workers submit semantically equivalent captions that inadvertently differ from other workers. The data showed that differences were often the result of writing style, use of contractions, or simple misspellings. To account for this, a set of rules may be used to homogenize (“normalize”) the input without altering meaning. In an embodiment, aspell (aspell.net) was used to correct misspellings, and a simple filter was used to address common abbreviations and contractions.

Metrics for Evaluating Captioning Systems

Determining the quality of captions is difficult. The most common method is word error rate (“WER”), which performs a best-fit alignment between the caption and the ground truth. The WER is then calculated as the sum of the substitutions (S), the deletions (D), and the insertions (I) needed to make the two transcripts match divided by the total number of words in the ground truth caption (N), or

$$\frac{S + D + I}{N} .$$

A key advantage of human captionists over ASR is that humans tend to make more reasonable errors because they are able to infer meaning from context, influencing their prior probability toward words that make sense in context. As such, SCRIBE is more usable than automated systems even when the results of traditional metrics are similar. FIG. 16 gives an example of the confusing errors often made by ASR, substituting “twenty four lexus” for “two-fold axis.”

Two other metrics were defined in addition to WER to help characterize the performance of real-time captioning. These additional metrics are particularly useful in understanding the potential of various approaches. The first is coverage, which represents how many of the words in the true speech signal appear in the merged caption. While similar to ‘recall’ in information retrieval, in calculating coverage a word in the caption is required to appear no later than 10 seconds after the word in the ground truth, and not before it, to count. Similarly, precision is the fraction of words in the caption that appear in the ground truth within 10 seconds.

Finally, for real-time captioning, latency is also important. Calculating latency is not straightforward because workers' noisy partial captions (worker text streams) differ from the ground truth. Latency was measured by first aligning the test captions to the ground truth using the Needleman-Wunsch sequence alignment algorithm, and then averaging the latency of all matched words. In order for deaf or hard-of-hearing individuals to participate in a conversation or in a lecture, captions must be provided quickly (within about 5-10 seconds).

Experiments

Twenty undergraduate students were recruited to act as non-expert captionists. These students had no special training, or previous formal experience transcribing audio. The participants were asked to transcribe four three-minute audio clips from MIT OpenCourseWare lectures (ocw.mit.edu). These inputs were aligned offline with an expert-transcribed baseline using the Needleman-Wunsch dynamic sequence alignment algorithm. Workers were compared with Nuance's Dragon Dictate 2 ASR on three measures: (i) coverage, the number of words spoken that were transcribed by some worker; (ii) accuracy, the number of words entered by workers that corresponded to a spoken word; and (iii) latency, the average time taken for some worker to input a correct caption.

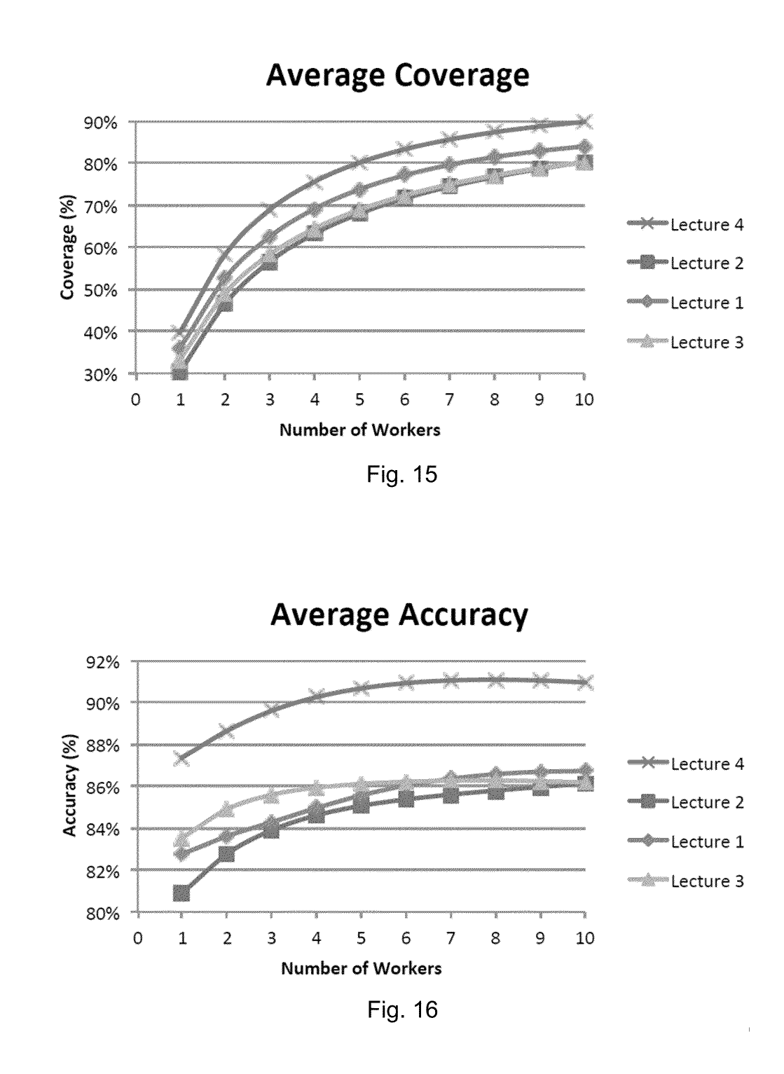

Results show that workers can outperform ASR, and that more workers lead to better results (see FIGS. 15 and 16). The average latency across these tasks was 3.87 seconds which is sufficient for “real-time” captioning. Tests with an exemplary combiner embodiment show that both the coverage and accuracy can be improved over that of a single worker. Since the present approach can filter worker input, higher accuracy can be achieved than groups of workers using alignment. One example with 5 workers averaged 94% accuracy compared to 86% using alignment.

Altered Audio Stream Experiments

In another experiment where the use of dynamic in-periods and out-periods were tested, 24 crowd workers were recruited from Mechanical Turk. Twelve of the workers were provided with fixed segments, and twelve were provided with adaptive segments. The workers were paid $0.05 for the task and could make an additional $0.002 bonus per word. Trials were randomized and workers were not able to repeat the task. Each trial consisted of captioning a 2:40 minute audio clip. Each segment consisted of only a few seconds of content to caption, so the clip was long enough to learn improved segment durations and test workers' abilities.

Using adaptive segments lead to a significant increase of 54.15% in the overall coverage, from 14.76% to 22.76% (p<0:05), and of 44.33% in F1 score, from 0:242 to 0:349 (p<0:05). Accuracy fell slightly from 84.33% to 80.11%, and latency improved from 5.05 seconds to 4.98 seconds, but these changes were not significant.

While even the improved coverage seems low upon initial inspection, it is important to note that the default task assumes that a worker with perfect accuracy and ability to cover all of the content assigned to them will achieve a coverage of approximately 25% (depending on speaker speed fluctuations). Therefore, by increasing coverage from 14.76% to 22.76% coverage, using adaptive segments essentially improved from 59.04% of this goal to 91.04%.

Further Experiments

Additional experiments were run to test the ability of non-expert captionists drawn from both local and remote crowds to provide captions that cover speech, and then evaluate approaches for merging the input from these captionists into a final real-time transcription stream. A data set of speech was selected from freely available lectures on MIT OpenCourseWare (http://ocw.mit.edu/courses/). These lectures were chosen because an objective of SCRIBE is to provide captions for classroom activities, and because the recording of the lectures often captures multiple speakers (e.g., students asking questions). Four 5-minute segments were chosen that contained speech from courses in electrical engineering and chemistry. These segments were professionally transcribed at a cost of $1.75 per minute. Despite the high cost of the professional transcription, a number of errors and omissions were found, and these were corrected to obtain a completely accurate baseline.

The study used twenty local participants. Each participant captioned 23 minutes of aural speech over a period of approximately 30 minutes. Participants first took a standard typing test and averaged a typing rate of 77.0 WPM (SD=15.8) with 2.05% average error (SD=2.31%). The participants were then introduced to the real-time captioning interface, and the participants captioned a 3-minute clip using the interface. Participants were then asked to caption the four 5-minute clips, two of which were selected to contain saliency adjustments.

One measure of the effectiveness of the present approach is whether or not groups of non-experts can effectively cover the speech signal. If some part of the speech signal is never typed then it will never appear in the final output, regardless of merging effectiveness. The precision and WER of the captions was also measured.

Multiple Sequence Alignment

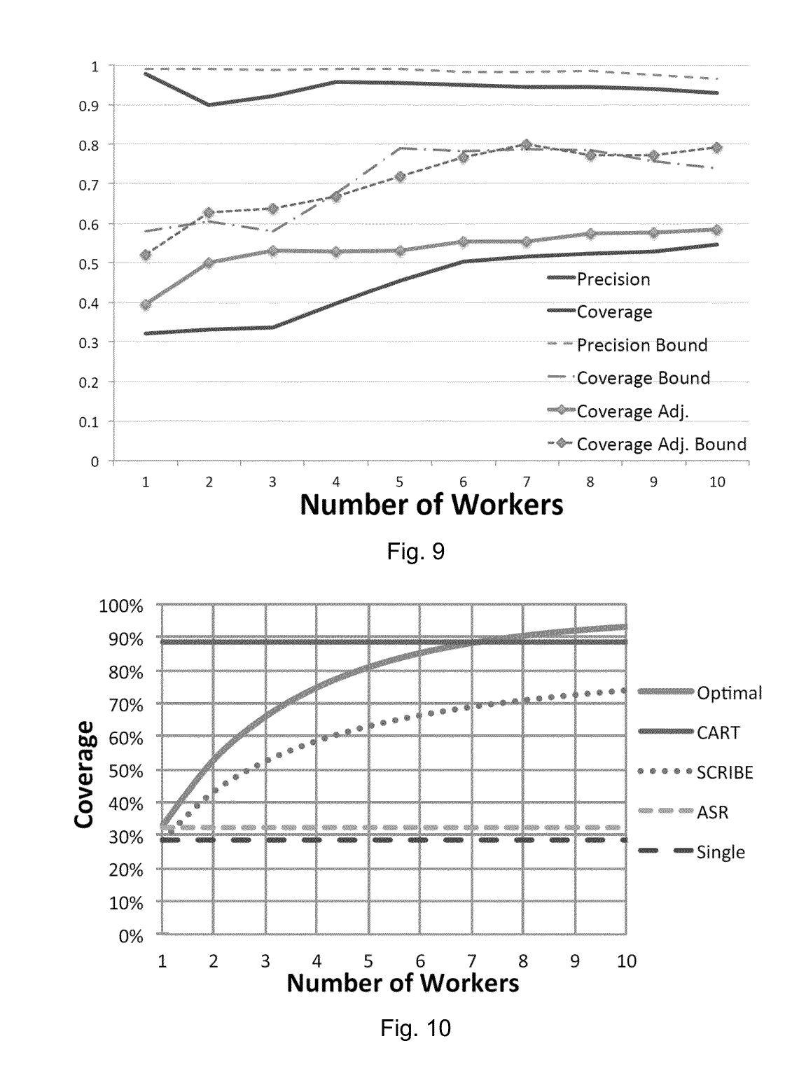

FIG. 9 shows precision and coverage plots for the MSA algorithm using multiple workers. The metrics are calculated at a character level and averaged over all subsets of workers and over all audio clips. It can be seen that precision is not significantly impacted by the number of workers, whereas coverage significantly improves as additional captionists are used. The theoretical upper bounds in FIG. 9 for both precision and coverage show what can be attained by a fully informed MSA with access to ground truth. This shows that this embodiment of SCRIBE is extracting nearly all of the information it can in terms of precision, but could improve in terms of coverage.

Note that adjusting the saliency dramatically improves coverage, as compared to no adjustments (FIG. 9). For example, only 2 workers are needed to achieve 50% coverage when using adjustments, while 6 workers are required to produce the same level with no adjustments.

Real-time Combiner

In testing, an average worker achieved 29.0% coverage, ASR achieved 32.3% coverage, CART achieved 88.5% coverage, and SCRIBE reached 74% out of a possible 93.2% coverage using 10 workers (FIG. 10). Groups of workers also had an average latency of 2.89 seconds (including network latency), significantly improving on CART's latency of 4.38 seconds. Results show that SCRIBE is easily able to outperform the coverage of both ASR and lone workers. Additionally, the number and types of errors in ASR captions make it far less useful to a user trying to comprehend the content of the audio. Using a naive approach (optimal coverage curve), which combines input based only on timestamp, shows that multiple workers have the potential to surpass CART with respect to coverage. Latency is also improved since multiple concurrent workers will naturally interleave answers, so that no one worker falling behind will delay the whole system, unlike a single-captionist approach such as CART.

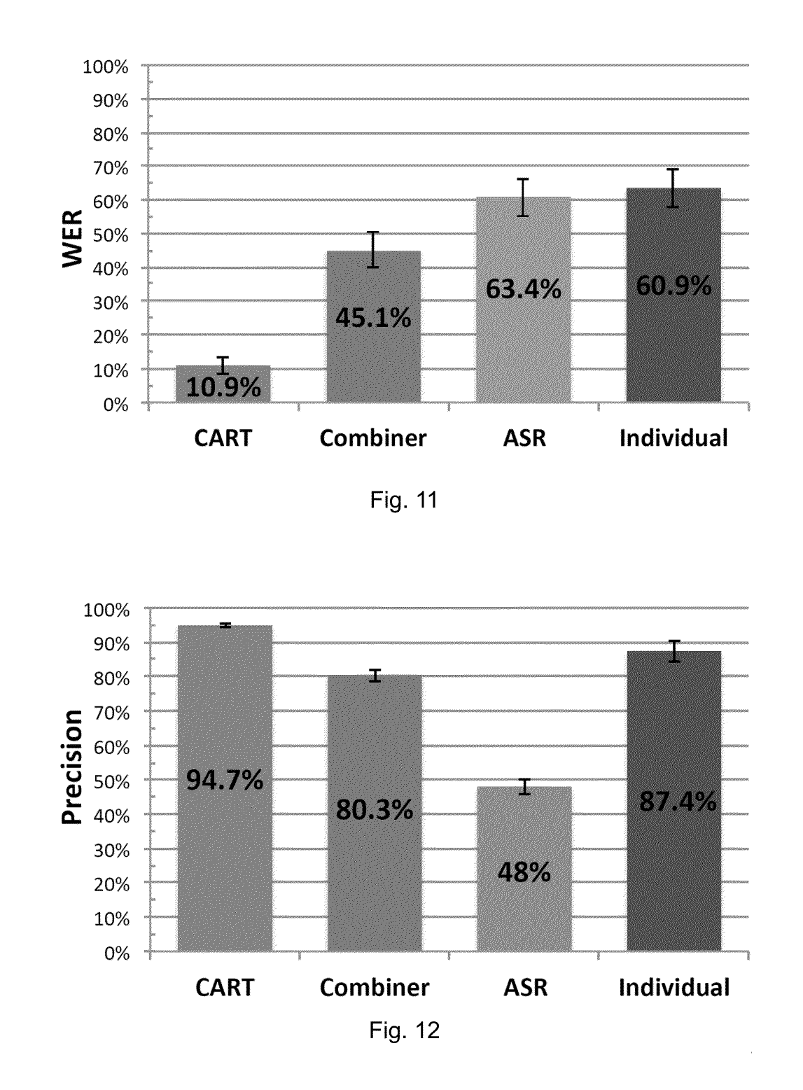

FIG. 11 shows WER results from the captioning systems. For this example, the combiner was tuned to balance coverage and precision, getting an average of 66% and 80.3% respectively. As expected, CART outperforms the other approaches. However, the combiner presents a clear improvement over both ASR and a single worker. The precision of each system is shown in FIG. 12. Because the input of multiple workers is merged, the combiner occasionally includes repeated words, which are marked as incorrect according to the metrics. The difference is that SCRIBE can be tuned to reach arbitrarily high accuracies, at the expense of coverage. This tradeoff is discussed in the next section.

Adjusting Tradeoffs

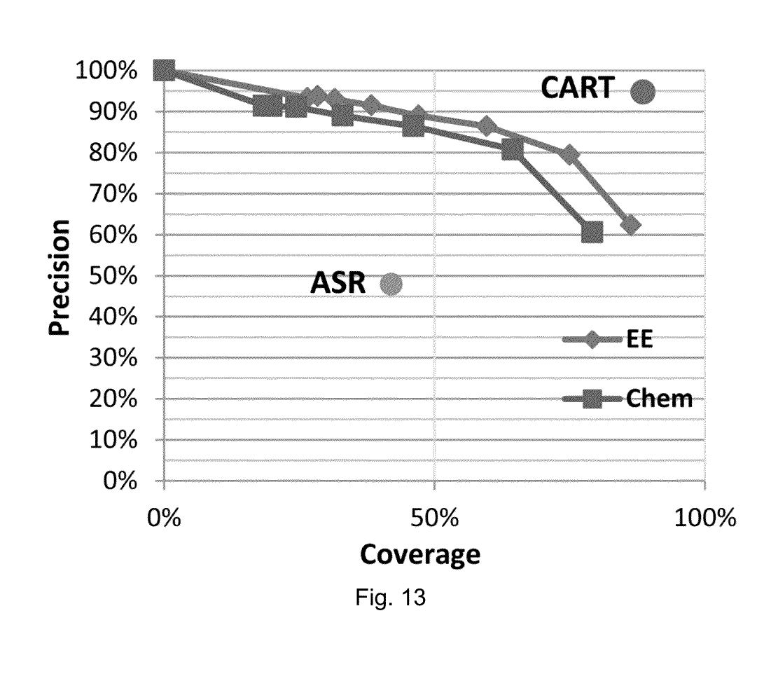

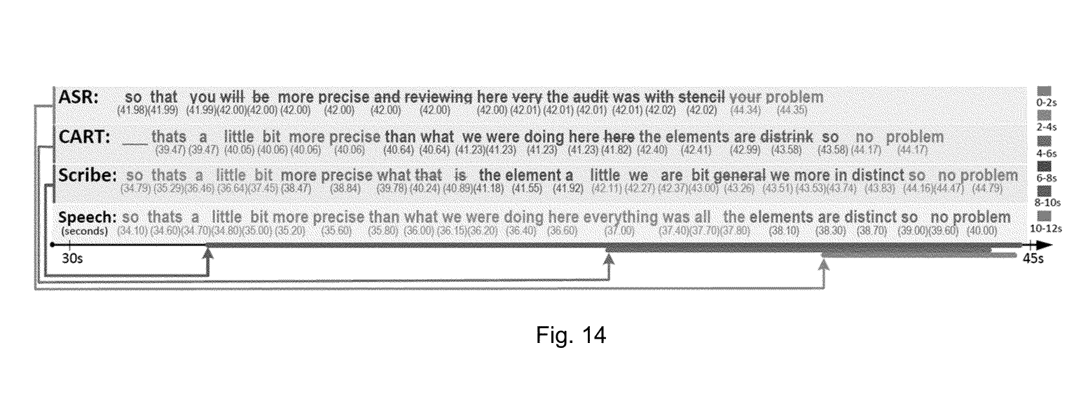

The input combiner is parameterized and allows users to actively adjust the tradeoff between improving coverage and improving precision while they are viewing the captions. To increase coverage, the combiner reduces the number of workers required to agree on a word before including it in the final caption. To increase accuracy, the combiner increases the required agreement. FIG. 13 shows tradeoffs users can make by adjusting these settings.

Saliency Adjustment

Interface changes designed to encourage workers to type different parts of the audio signal were also tested. For all participants, the interface indicated that they should be certain to type words appearing during a four second period followed by six seconds in which they could type if they wanted to. The 10 participants who typed using the modified version of the interface for each 5-minute file were assigned offsets ranging from 0 to 9 seconds.

In the experiments, it was found that the participants consistently typed a greater fraction of the text that appeared in the periods in which the interface indicated that they should. For the electrical engineering clip, the difference was 54.7% (SD=9.4%) for words in the selected periods as compared to only 23.3% (SD=6.8%) for word outside of those periods. For the chemistry clips, the difference was 50.4% (SD=9.2%) of words appearing inside the highlighted period as compared to 15.4% (SD=4.3%) of words outside of the period.

Mechanical Turk

The interface and captioning task was tested to see if it would make sense to workers on Mechanical Turk since such workers would not receive in-person instructions. quikTurkit was used to recruit a crowd of workers to caption the four clips (20 minutes of speech). The HITs (Human Intelligence Tasks) paid $0.05 and workers could make an additional $0.002 bonus per word. Workers were asked to first watch a 40-second video in which we describe the task. In total, 18 workers participated, at a cost of $13.84 ($36.10 per hour).

Workers collectively achieved a 78.0% coverage of the audio signal. The average coverage over just three workers was 59.7% (SD=10.9%), suggesting a conservative approach could be used to recruit workers and cover much of the input signal. Participating workers generally provided high-quality captions, although some had difficulty hearing the audio. Prior work has shown that workers remember the content of prior tasks, meaning that as more tasks are generated, the size of the trained pool of workers available on Mechanical Turk would be expected to increase. The high cost of alternatives means that workers can be well paid and still provide a cost effective solution.

TimeWarp

Another exemplary (non-limiting) embodiment of the present disclosure, TimeWarp, was used to test altering the audio to allow each worker to type slowed clips played as close to real-time as possible while still maintaining the context acquired by hearing all of the audio. This was done by balancing the play speed during in periods, where workers are expected to caption the audio and the playback speed is reduced, and out periods, where workers listen to the audio and the playback speed is increased. A cycle is one in period followed by an out period. At the beginning of each cycle, the worker's position in the audio is aligned with the real-time stream. To do this, the number of different sets of workers N that will be used in order to partition the stream is selected. The length of the in period is Pᵢ, the length of the out period is Pₒ, and the play speed reduction factor is r. Therefore, the playback rate during in periods is 1/r. The amount of the real-time stream that gets buffered while playing at the reduced speed is compensated for by an increased playback speed of

$$\frac{N - 1}{N - r}$$

during out periods. The result is that the cycle time of the modified stream equals the cycle time of the unmodified stream.

To set the length of Pᵢ for our experiments, a preliminary study was conducted with 17 workers drawn from Mechanical Turk. The mean typing speed of these workers was 42.8 WPM on a similar real-time captioning task. It was also found that a worker could type, at most, 8 words in a row on average before the per-word latency exceeded 8 seconds (the upper bound used for acceptable latency). Since the mean speaking rate is around 150 WPM, workers will hear 8 words in roughly 3.2 seconds, with an entry time of roughly 8 seconds from the last word spoken. This was used to set Pᵢ=3:25 s, Pₒ=9:75 s, and N=4. r=2 was used in the tests so that the playback speed would be

$$\frac{1}{2} = 0.5 x$$

for in periods, and the play speed for out periods was

$$\frac{N - 1}{N - r} = \frac{3}{2} = 1.5 x .$$

TimeWarp System Architecture

The system architecture is similar to the above SCRIBE embodiments. Audio was forwarded from a laptop or mobile device to a server running Flash Media Server (FMS). Since FMS does not allow access to the underlying waveform for live streams, N instances of FFmpeg (ffmpeg.org) were used to connect to FMS—one for each offset—then FFmpeg was used to modify the stream to play it faster or slower. The N streams were then forwarded to worker pages that present workers with the appropriate version of the audio. Worker input was then forwarded back to the server where it is recorded and scored for accuracy.

In order to speed up and slow down the play speed of content being provided to workers without changing the pitch (which would make the content more difficult to understand for the worker), the Waveform Similarity Based Overlap and Add (“WSOLA”) algorithm was used. WSOLA works by dividing the signal into small segments, then either skipping (to increase play speed) or adding (to decrease play speed) content, and finally stitching these segments back together. To reduce the number of sound artifacts, WSOLA finds overlap points with similar wave forms then gradually transitions between sequences during these overlap periods. Other algorithms may be used, such as, for example, the Phase Vocoder algorithm (which works in the frequency domain), or a specialized version of WSOLA—Time Domain Pitch Synchronous Overlap and Add (TD-PSOLA)—designed for pitch consistency.

Once the audio was streaming, workers were shown a captioning interface with a text box to enter captions in, a score box which tracks the points workers have earned, and visual and audio alerts telling them when they should or should not be captioning. Visual alerts include a status message that changes between a green “type what you hear now” alert and a red “do not type” alert. Workers were able to see an animation of the points they earned flying from the word they input to the score box and being added to their total. Audio cues were used to signal each worker to start and stop captioning, and volume adjustments were used to reduce the volume of content that each worker was not required to caption. The volume was lowered rather than muted in order to help workers maintain context even when they were not actively captioning.

Results of testing with TimeWarp showed improved worker's coverage, precision, and latency on the real-time captioning task. While individual workers were still short of being able to reliably caption the requested content entirely on their own, multiple workers were leveraged in order to reach coverage rates exceeding 90%. The effect of TimeWarp was particularly positive for remote workers (e.g., those on Mechanical Turk).

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A computer-based method for captioning aural speech using a plurality of workers, comprising the steps of:
receiving from each worker, an electronic worker text stream comprising an approximate transcription of at least a portion of the aural speech created by the corresponding worker;
aligning each of the worker text streams with one another; and
combining the aligned worker text streams into a caption of the aural speech.

2. The method of claim 1, further comprising the steps of:
receiving an electronic audio stream of the aural speech; and
providing at least a portion of the audio stream to each of the plurality of workers.

3. The method of claim 2, wherein portions of the audio stream are provided to each of the plurality of workers such that the entire audio stream is covered by the plurality of workers.

4. The method of claim 2, wherein at least a portion of the audio stream provided to the at least one worker of the plurality of workers is altered to change the audio saliency.

5. The method of claim 4, wherein the altered portion of the audio stream is louder than the unaltered portion of the audio stream.

6. The method of claim 4, wherein the altered portion of the audio stream is slower than the unaltered portion of the audio stream.

7. The method of claim 3, wherein a duration of the portion of the audio stream is fixed.

8. The method of claim 3, wherein a duration of the portion of the audio stream is determined dynamically based on a performance of the worker.

9. The method of claim 3, wherein the portion of the audio stream is provided to more than one of the plurality of workers, and at least two of the workers are provided with different portions of the audio stream.

10. The method of claim 1, further comprising the step of normalizing each worker stream.

11. The method of claim 10, wherein normalizing each worker stream includes correcting misspelled words, replacing contractions, determining a probability of a word based on a language model; and/or determining a probability of a word based on a typing model.

12. The method of claim 1, further comprising the step of determining a performance of at least one of the workers based on the agreement of the worker stream of said worker with the worker streams of the other workers.

13. The method of claim 2, wherein at least one of the plurality of workers is an automated speech recognition (“ASR”) system.

14. The method of claim 13, further comprising the step of providing the caption to the ASR system to improve the ASR system.

15. The method of claim 13, wherein more than one of the plurality of workers is an ASR system.

16. The method of claim 1, wherein the caption is generated real-time with the aural speech.

17. The method of claim 16, wherein the latency between any portion of the aural speech and the corresponding portion of the caption is no more than 5 seconds.

18. The method of claim 1, further comprising the step of recruiting the workers to transcribe the aural speech.

19. A system for captioning aural speech using a plurality of workers, comprising:
a plurality of worker interfaces for providing worker audio streams of the aural speech to workers, the each worker interface configured to receive text from the corresponding worker by way of an input device and transmit the received text as a worker text stream; and
a transcription processor programmed to:
retrieve an audio stream;
send at least a portion of the audio stream to each worker interface of the plurality of worker interfaces as worker audio streams;
receive worker text streams from the plurality of worker interfaces;
align the worker text streams with one another; and
combine the aligned worker text streams into a caption stream.

20. The system of claim 19, further comprising a user interface for requesting a transcript of the aural speech, the user interface configured to cooperate with an audio input device to convert the aural speech into an audio stream.

21. The system of claim 19, wherein the transcription processor is further programmed to alter the audio saliency of at least one worker audio stream.

22. The system of claim 21, wherein at least one worker audio stream is altered such that portions of the worker audio stream are louder than the remainder of the worker audio stream.

23. The system of claim 21, wherein at least one worker audio stream is altered such that portions of the worker audio stream are slower than the remainder of the worker audio stream.

24. The system of claim 19, wherein each worker interface is configured to lock the text received from the worker to prevent modification of the text.
